(19) United States
(12) Patent Application Publication
(10) Pub. No.: US 2026/0362307 A1
(43) Pub. Date: Nov. 12, 2026

(54) USING A USER EQUIPMENT WITH A MOBILE COMMUNICATION NETWORK AND/OR FOR AN ENERGY-SAVING OPERATION OF THE USER EQUIPMENT WITH THE MOBILE COMMUNICATION NETWORK

(71) Applicant: Deutsche Telekom AG, Bonn (DE)

(72) Inventor: Axel Klatt, Cologne (DE)

(21) Appl. No.: 19/486,964

(22) PCT Filed: May 15, 2024
(86) PCT No.: PCT/EP2024/063388

§ 371 Date: Nov. 24, 2025

(30) Foreign Application Priority Data
May 30, 2023 (EP) 23176091.9

(51) Int. Cl. H04W 48/18

(52) U.S. Cl. CPC H04W 48/18

(57) ABSTRACT

A method for using a user equipment and/or for an energy-saving operation of the user equipment includes: the user equipment is served by a terrestrial radio access network and detects a loss of radio coverage provided by the terrestrial radio access network; the user equipment applies a delay time interval prior to initiating a selection procedure with regard to a non-terrestrial radio access network, the selection procedure being according to one or more categories of selection procedures; and in case that loss of radio coverage provided by the terrestrial radio access network is still detected upon expiry of the delay time interval, the user equipment initiates the selection procedure with regard to the non-terrestrial radio access network, or in case that the user equipment regains radio coverage provided by the terrestrial radio access network, the user equipment continues to be served by the terrestrial radio access network.

### CROSS-REFERENCE TO PRIOR APPLICATIONS

This application is a U.S. National Phase application under 35 U.S.C. § 371 of International Application No. PCT/EP2024/063388, filed on May 15, 2024, and claims benefit to European Patent Application No. EP 23176091.9, filed on May 30, 2023. The International Application was published in English on Dec. 5, 2024 as WO 2024/245756 A1 under PCT Article 21(2).

### FIELD

The present invention relates a method for using a user equipment with a mobile communication network and/or for an energy-saving operation of the user equipment with the mobile communication network, wherein the mobile communication network provides communication services to the user equipment using a radio access network that serves or provides radio coverage to the user equipment, wherein at least a part of the radio access network corresponds to a terrestrial radio access network that provides radio access network functionality to the user equipment, wherein additional, or complemental, radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network.

Furthermore, the present invention relates to a user equipment for being used with a mobile communication network and/or for being operated in or according to an energy-saving configuration of the user equipment with the mobile communication network, wherein the user equipment is configured such that the mobile communication network is able to provide communication services to the user equipment using a radio access network that serves or provides radio coverage to the user equipment, at least a part of the radio access network corresponding to a terrestrial radio access network that provides radio access network functionality to the user equipment, wherein the user equipment is furthermore configured such that additional, or complemental, radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network.

Additionally, the present invention relates to a system or mobile communication network for using a user equipment with the mobile communication network and/or for an energy-saving operation of the user equipment with the mobile communication network, wherein the mobile communication network provides communication services to the user equipment using a radio access network that serves or provides radio coverage to the user equipment,

wherein at least a part of the radio access network corresponds to a terrestrial radio access network that provides radio access network functionality to the user equipment, wherein additional, or complemental, radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network.

Furthermore, the present invention relates to a program and to a computer-readable medium for using a user equipment with a mobile communication network and/or for an energy-saving operation of the user equipment with the mobile communication network according to exemplary embodiments of the inventive method.

### BACKGROUND

Mobile communication networks such as public land mobile networks are typically realized as cellular mobile communication networks, i.e. comprising (or using or being associated or assigned to a radio access network comprising) radio cells. Such cellular systems are known conforming to different mobile communication standards or radio access technologies, like 2G/3G/4G/5G/6G radio access technologies (referring to the different generations of radio access technologies) and typically comprise (or consist of) cells (or radio cells) of one or a plurality of the respective radio access technology/radio access technologies. Such mobile communication networks that are purely or predominantly based on terrestrial infrastructures of the radio access network are typically organized throughout a country (or a part of or a region within a country) in a repeating pattern of typically stationary (radio) cells (and associated base station entities) which typically belong to (or are used by or associated or assigned to) a mobile network operator (MNO).

Modern mobile communication networks, such as 5G systems, especially using 5G NR (new radio) radio (access) technology, are evolving using air-based and/or space-based infrastructure, hence relying, at least partly, on non-terrestrial infrastructure, especially in the form of satellites and/or high altitude platforms, HAPs, thereby realizing non-terrestrial networks, NTN (or satellite communication networks). Examples of such air-based and/or space-based network infrastructure include, e.g., mobile satellite connectivity with low earth orbit (LEO) satellites, medium earth orbit (MEO) satellites and/or geostationary earth orbit (GEO) satellites and also so-called high-altitude platforms or high-altitude pseudo-satellites (HAPS).

Such non-terrestrial networks are able to provide global cellular connectivity to handheld devices or user equipments, typically using satellite or HAP coverage, e.g. using earth-fixed beams or service links, quasi-earth fixed beams or service links and/or earth-moving beams or service links; of course, this being possible—due to the movement of such satellites and/or HAPS relative to the earth surface—only during certain, comparatively short, time intervals of, at most, the order of a couple of minutes in the case of satellites.

One possibility of using non-terrestrial (radio access) networks is to complement the radio coverage—in a certain geographical area—provided by a terrestrial (radio access) network (in that considered geographical area), i.e. satellite networks or non-terrestrial networks will complement terrestrial cellular networks with the aim of using the non-terrestrial radio access network only where the radio coverage provided by the terrestrial radio access network is not sufficient (this also being called “white spots” of, or within, terrestrial radio access networks), thereby striving to provide—as much as possible and in case it is efficient to provide an increase in the user experience—a seamless service experience for user equipments or users of the mobile communication network.

However, in general, the capabilities and resulting data rates of non-terrestrial (radio access) networks compared to terrestrial (radio access) networks are likely to be limited, simply due to physical limitations, and—additionally and especially—the use of such non-terrestrial (radio access) networks likely requires more energy, e.g., per amount of data transmitted or per quality-of-service (especially latency) provided, compared to using terrestrial radio access networks. Typically, such required increased amounts of energy are necessary on both sides of the air interface, i.e. both at the user equipment as well as on the (radio access) network side.

In terrestrial mobile communication networks, the typical approach for providing radio coverage to a certain geographic area and/or to a certain number of user equipments is via using base station entities that are typically stationary and wherein each base station entity serves a radio cell (or a plurality of radio cells) that is (are) likewise typically rather stationary, i.e. a considered radio cell is typically roughly centered (or otherwise rather stationarily positioned) relative to an antenna entity of or associated with the considered base station entity that serves the considered radio cell or geographical area thereof. Of course, in case that a plurality of such base station entities are required—e.g. in view of a larger geographic area to be covered and/or in view of a higher (peak) demand for mobile communication services to be provided—a plurality of such mostly stationary base station entities are used, each one serving a radio cell (or a plurality of radio cells) that is (are) likewise typically rather stationary.

In order to complement (via a non-terrestrial (radio access) network) the radio coverage (or radio access network functionality) provided by a terrestrial (radio access) network in order to provide radio coverage also in such above-mentioned white spot-areas (of the terrestrial radio access network), conventionally known approaches within mobile communication networks mainly provide rather inflexible solutions or solutions requiring specifically configured user equipments or user interaction, such as, e.g., requiring manual interaction by the user, or relaying on app-based selection of the non-terrestrial network, or, alternatively, applying steering of user equipments (from the terrestrial radio access network (at loss of radio coverage) to the non-terrestrial radio access network) for all users (e.g. within a radio cell or beyond) in a similar manner, especially as the applied rules regarding (and defining) features or procedures such as public land mobile network selection, cell selection, or cell re-selection are applied for all user equipments irrespective of the individual situation thereof and especially without specifically taking into account complementing terrestrial radio access network functionality via non-terrestrial radio access network functionality.

### SUMMARY

In an exemplary embodiment, the present invention provides a method for using a user equipment with a mobile communication network and/or for an energy-saving operation of the user equipment with the mobile communication network. The mobile communication network provides communication services to the user equipment using a radio access network that serves or provides radio coverage to the user equipment. At least a part of the radio access network corresponds to a terrestrial radio access network that provides radio access network functionality to the user equipment. Additional radio access network functionality is able to be provided, to the user equipment, via a non-terrestrial radio access network. The user equipment is able to switch or to be switched from being provided with radio access network functionality either via the terrestrial radio access network or via the non-terrestrial radio access network. The method comprises the following steps: in a first step, the user equipment is served by the terrestrial radio access network and detects a loss of radio coverage provided by the terrestrial radio access network; in a second step, the user equipment applies a delay time interval prior to initiating a selection procedure with regard to the non-terrestrial radio access network, the selection procedure being according to one or more categories of selection procedures; and in a third step: in case that loss of radio coverage provided by the terrestrial radio access network is still detected upon expiry of the delay time interval, the user equipment initiates the selection procedure with regard to the non-terrestrial radio access network, or in case that the user equipment regains radio coverage provided by the terrestrial radio access network, the user equipment continues to be served by the terrestrial radio access network.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates the situation of a user equipment in a mobile communication network wherein the mobile communication network comprises a radio access network with at least a terrestrial radio access network (part) that is able to provide the user equipment with radio access network functionality, wherein, furthermore, the user equipment is able to be provided with radio access network functionality via a non-terrestrial radio access network, that is able to complement the radio coverage provided by the terrestrial radio access network.

FIG. 2 schematically and exemplarily illustrates timing details that are related to the method—and that are applied by the user equipment—according to the present invention.

### DETAILED DESCRIPTION

Exemplary embodiments of the present invention is provide a technically simple, effective, cost-effective, and, especially, energy-saving solution for complementing terrestrial radio access network functionality via non-terrestrial radio access network functionality (i.e. via potentially switching (or not) the user equipment from being provided with radio access network functionality either via the terrestrial radio access network or via the non-terrestrial radio access network) in a manner such that the user experience—of a user or a user equipment used with a mobile communication network and/or for an energy-saving operation of the user equipment with the mobile communication network—is either enhanced or, at least, only reduced in the least possible way. Exemplary embodiments of the present invention further provide a corresponding user equipment, a corresponding system or mobile communication network, and a corresponding program and computer-readable medium.

In an exemplary embodiment, the present invention provides a method for using a user equipment with a mobile communication network and/or for an energy-saving operation of the user equipment with the mobile communication network, wherein the mobile communication network provides communication services to the user equipment using a radio access network that serves or provides radio coverage to the user equipment, wherein at least a part of the radio access network corresponds to a terrestrial radio access network that provides radio access network functionality to the user equipment, wherein additional, or complemental, radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network,

wherein, in order to use or to operate the user equipment in a situation of low or inexistent radio access network functionality being provided or able to be provided via the terrestrial radio access network, the method comprises the following steps:
in a first step, the user equipment is served by the terrestrial radio access network and detects a loss of radio coverage provided by the terrestrial radio access network,
in a second step, the user equipment applies a delay time interval prior to initiating a selection procedure at least with regard to the non-terrestrial radio access network, the selection procedure being according to one category of selection procedures or according to a plurality of categories of selection procedures,
in a third step,
   in case that loss of radio coverage provided by the terrestrial radio access network is still detected upon expiry of the delay time interval, the user equipment initiates the selection procedure with regard to the non-terrestrial radio access network, and alternatively,
   in case that the user equipment regains radio coverage provided by the terrestrial radio access network, the user equipment continues to be served by the terrestrial radio access network.

It is thereby advantageously possible according to the present invention to provide an optimized manner for complementing terrestrial radio access network functionality via non-terrestrial radio access network functionality. According to the present invention, this is done via timely modulating the initiation of at least one category of selection procedures (but preferably via timely modulating the initiation of all of the selection procedures regarding public land mobile network selection, cell selection and cell re-selection), which—in certain cases or scenarios of user equipments—results in switching the user equipment to being provided, typically temporarily, with radio access network functionality via the non-terrestrial radio access network instead of via the terrestrial radio access network (due to a detected loss of coverage by the terrestrial radio access network), and—in certain other cases or scenarios of user equipments—results in not switching towards the non-terrestrial radio access network (despite detected (temporary) loss of coverage by the terrestrial radio access network).

Hence, according to the present invention, it is advantageously possible to provide for a functionality that takes the current situation of the user equipment (at a certain location when the terrestrial radio access network is lost) into account in order to avoid to unnecessarily switch over from (being provided with radio coverage via) the terrestrial radio access network to (being provided with radio coverage via) the non-terrestrial radio access network and back to the terrestrial radio access network. In many situations, (radio coverage from) the terrestrial radio access network might be lost only temporarily, i.e. for comparatively short times (e.g., some seconds or—at most—a couple of minutes), especially for user equipments that are moving on the ground; in such situations, radio coverage provided by the terrestrial radio access network might be regained again quickly, and such a rather quick change (or switch of the user equipment) from the terrestrial radio access network to the non-terrestrial radio access network and back to the terrestrial radio access network could advantageously be avoided in order not only to minimize signaling effort (and, hence, network load), but also to minimize performing corresponding registration procedures, using related radiofrequency power and causing a waste of energy not only on the side of the user equipment but also regarding the (terrestrial and/or non-terrestrial) network.

Especially, the present invention addresses temporary losses of (radio coverage from) the terrestrial radio access network for user equipments that are moving, especially at different speeds.

According to the present invention, a user equipment is considered that is used with a mobile communication network, especially in order to provide for an energy-saving operation of the user equipment. The mobile communication network provides communication services to the user equipment using a radio access network that serves or provides radio coverage to the user equipment. At least a part of the radio access network (associated or assigned to the mobile communication network) corresponds to a terrestrial radio access network, i.e. the mobile communication network provides, using the assigned or associated radio access network, radio coverage and communication services (or, radio access network functionality) to the (considered) user equipment.

Additional, or complemental, radio access network functionality is able to be provided, to the user equipment, via a non-terrestrial radio access network.

According to the present invention, it is not excluded that such non-terrestrial radio access network is a part of the radio access network (associated with or assigned to the mobile communication network), i.e. that the radio access network (of the mobile communication network) comprises both a terrestrial radio access network part and a non-terrestrial radio access network part; however, the main case according to the present invention is directed to a situation where (regarding the considered user equipment) the radio access network (associated with or assigned to the mobile communication network) is, or corresponds to, a terrestrial radio access network, and where the non-terrestrial radio access network (that is able to provide additional, or complemental, radio access network functionality to the (considered) user equipment) is not associated with or assigned to the mobile communication network (providing the radio access network) but to another mobile communication network.

Hence, in the context of the present invention, the term radio access network (of the mobile communication network) primarily refers to the terrestrial radio access network (part) associated with or assigned to the mobile communication network.

According to the present invention and as well as it is conventionally known, the (considered) user equipment (being located at a specific geographical location—and having a certain mobility state or state of movement) is able to switch (or to be switched) from being provided with radio access network functionality either via the terrestrial radio access network or via the non-terrestrial radio access network.

According to the present invention, in order to use or to operate the user equipment in a situation of low or inexistent radio access network functionality being provided or able to be provided via the terrestrial radio access network, exemplary embodiments of the inventive method comprises the following steps:
in a first step, the user equipment is served by the terrestrial radio access network and detects a loss of radio coverage provided by the terrestrial radio access network,
in a second step, the user equipment applies—or, at least, is able to apply—a delay time interval prior to initiating a selection procedure (or, prior to initiating at least one kind, or category, of selection procedure), the selection procedure being according to one category (or kind) of selection procedures or according to a plurality of categories (or kinds) of selection procedures,
in a third step,
   in case that the loss of radio coverage (i.e. the radio coverage previously provided by the terrestrial radio access network) is still detected upon expiry of the delay time interval, the user equipment initiates the selection procedure (or the selection procedures) with regard to the non-terrestrial radio access network, and alternatively,
   in case that the user equipment regains radio coverage provided by the terrestrial radio access network (i.e. detects that radio coverage, provided by the terrestrial radio access network that previously provided radio coverage—especially via using the same base station entity (or radio cell) or another base station entity (or another radio cell) of that terrestrial radio access network—is (again) available), the user equipment continues to be served by the (same) terrestrial radio access network—especially via using the same base station entity (or radio cell) or via using another base station entity (or another radio cell) of that (same) terrestrial radio access network.
      Preferably according to the present invention, the user equipment applies—or, at least, is able to apply—the delay time interval prior to initiating a selection procedure at least with regard to the non-terrestrial radio access network, i.e. the user equipment applies, or—at least—is able to apply the delay time interval
prior to initiating the selection procedure both with regard to the terrestrial radio access network and with regard to the non-terrestrial radio access network, or
prior to initiating the selection procedure (only) with regard to the non-terrestrial radio access network.

Hence, according to the present invention, it is advantageously possible that—in situations of only rather short time periods of (detected) losses of radio coverage (being provided by the terrestrial radio access network), and due to the application of the delay time interval prior to performing (or initiating) the selection procedure at least with regard to the non-terrestrial radio access network—unnecessary switching of the user equipment, from the terrestrial radio access network to the non-terrestrial radio access network and back again to the terrestrial radio access network, are able to be avoided, thereby, especially, saving the required amount of energy (especially on the user equipment side) for conducting such two switching operations, forth and back.

According to the present invention, it is advantageously possible and preferred that the selection procedure whose initiation is delayed, in the second step, by the application of the delay time interval corresponds to at least one out of the following, preferably to all out of the following:
a public land mobile network selection procedure,
a cell selection procedure,
a cell re-selection procedure.

It is thereby advantageously possible to realize and implement exemplary embodiments of the inventive method in a comparatively simple and efficient manner.

According to the present invention, it is advantageously furthermore possible and preferred that the delay time interval actually applied corresponds to—or is, at least partly, defined by or dependent on—a time to select satellite parameter, TSS parameter, or its information content, wherein the time to select satellite parameter is received, by the user equipment, from the terrestrial radio access network, especially from a base station entity thereof and especially from the base station entity serving the user equipment at, or prior to, the point in time when, during the first step, the user equipment detects the loss of radio coverage.

It is thereby advantageously possible to realize and implement exemplary embodiments of the inventive method in a comparatively simple and efficient manner.

According to the present invention, it is furthermore advantageously possible and preferred that the delay time interval that is actually applied depends—in addition to the information content of the time to select satellite parameter—also on at least one out of the following:
a direction of movement information of the user equipment relating to in which direction the user equipment is heading and/or
a location information of the user equipment, especially a combination of a direction of movement information of the user equipment relating to in which direction the user equipment is heading and from which location of the user equipment,
a mobility mode or a mobility state criterium of the user equipment, especially on whether the user equipment rather is or corresponds to one out of the following:
   stationary or quasi-stationary or not moving,
   comparatively slow moving or normal-mobility state criterium,
   comparatively faster moving or medium-mobility state criterium,
   moving at high-speed or high-mobility state criterium,
      wherein especially the delay time interval that is actually applied is determined based on the information content of the time to select satellite parameter, wherein this value is increased or decreased dependent on the direction of movement information of the user equipment and/or the location information of the user equipment and/or the mobility mode of or the mobility state criterium applicable to the user equipment.

It is thereby advantageously possible to realize and implement exemplary embodiments of the inventive method in a comparatively simple and efficient manner.

According to the present invention, it is furthermore advantageously possible and preferred that the delay time interval that is actually applied depends on
a user-defined and/or network-defined and/or service-defined individual or dedicated setting solely, or
the user-defined and/or network-defined and/or service-defined individual or dedicated setting in addition to the information content of the time to select satellite parameter.

It is thereby advantageously possible to realize and implement exemplary embodiments of the inventive method in a comparatively simple and efficient manner.

Furthermore, it is advantageously possible and preferred according to the present invention that the time to select satellite parameter is broadcast, by at least one out of the base station entities of the terrestrial radio access network, especially by the base station entity currently or previously serving the user equipment,

wherein a broadcast channel is used to transmit the time to select satellite parameter,
wherein this broadcasting is performed using a system information block that is relevant for all user equipments in the considered radio cell.

It is thereby advantageously possible to realize and implement exemplary embodiments of the inventive method in a comparatively simple and efficient manner.

According to the present invention, it is furthermore advantageously possible and preferred that the time to select satellite parameter is transmitted, to the user equipment, by the base station entity currently or previously serving the user equipment via using a dedicated signaling channel,

wherein especially the time to select satellite parameter is transmitted as part of, or during, one out of the following:
the registration process of the user equipment with the mobile communication network and/or the terrestrial radio access network,
a regular non-access stratum procedure of the user equipment with the mobile communication network and/or the terrestrial radio access network, especially a tracking area update, TAU, procedure,
a regular access stratum procedure of the user equipment with the mobile communication network and/or the terrestrial radio access network, especially a measurement control procedure.

It is thereby advantageously possible to realize and implement exemplary embodiments of the inventive method in a comparatively simple and efficient manner.

Furthermore, it is advantageously possible and preferred according to the present invention that the time to select satellite parameter is stored in a memory element or module of or within the user equipment and/or

wherein one specific information content of the time to select satellite parameter is such that the time to select satellite parameter indicates—in case of having this specific information content—that the delay time interval applied in the second step is set to zero or corresponds to zero seconds, resulting in the user equipment immediately initiating the selection procedure with regard to the non-terrestrial radio access network if it detects a loss of radio coverage provided by the terrestrial radio access network.

It is thereby advantageously possible to realize and implement exemplary embodiments of the inventive method in a comparatively simple and efficient manner.

According to the present invention, it is furthermore advantageously possible and preferred that the information content of the time to select satellite parameter is such that the time to select satellite parameter indicates—in case of having this specific information content—that the delay time interval corresponds to 10 seconds, or to 20 seconds, or to 30 seconds, or to other multiples of 10 seconds, especially up to 360 seconds.

It is thereby advantageously possible to realize and implement exemplary embodiments of the inventive method in a comparatively simple and efficient manner.

Furthermore, the present invention relates to a user equipment for being used with a mobile communication network and/or for being operated in or according to an energy-saving configuration of the user equipment with the mobile communication network, wherein the user equipment is configured such that the mobile communication network is able to provide communication services to the user equipment using a radio access network that serves or provides radio coverage to the user equipment, at least a part of the radio access network corresponding to a terrestrial radio access network that provides radio access network functionality to the user equipment, wherein the user equipment is furthermore configured such that additional, or complemental, radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network,

wherein, in order to use or to operate the user equipment in a situation of low or inexistent radio access network functionality being provided or able to be provided via the terrestrial radio access network, the user equipment is configured such that the user equipment, in case that the user equipment—while being served by the terrestrial radio access network detects a loss of radio coverage provided by the terrestrial radio access network, applies a delay time interval prior to initiating a selection procedure at least with regard to the non-terrestrial radio access network, the selection procedure being according to one category of selection procedures or according to a plurality of categories of selection procedures, wherein
in case that loss of radio coverage provided by the terrestrial radio access network is still detected upon expiry of the delay time interval, the user equipment initiates a cell selection procedure with regard to the non-terrestrial radio access network, and alternatively,
in case that the user equipment regains radio coverage provided by the terrestrial radio access network, the user equipment continues to be served by the terrestrial radio access network.

Furthermore, the present invention relates to a system or to a mobile communication network for using a user equipment with the mobile communication network and/or for an energy-saving operation of the user equipment with the mobile communication network, wherein the mobile communication network provides communication services to the user equipment using a radio access network that serves or provides radio coverage to the user equipment,

wherein at least a part of the radio access network corresponds to a terrestrial radio access network that provides radio access network functionality to the user equipment, wherein additional, or complemental, radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network,
wherein, in order to use or to operate the user equipment in a situation of low or inexistent radio access network functionality being provided or able to be provided via the terrestrial radio access network, the system or mobile communication network is configured such that:
the user equipment is served by the terrestrial radio access network and detects a loss of radio coverage provided by the terrestrial radio access network,
the user equipment applies a delay time interval prior to initiating a selection procedure at least with regard to the non-terrestrial radio access network, the selection procedure being according to one category of selection procedures or according to a plurality of categories of selection procedures,
   wherein
in case that loss of radio coverage provided by the terrestrial radio access network is still detected upon expiry of the delay time interval, the user equipment initiates a cell selection procedure with regard to the non-terrestrial radio access network, and alternatively,
in case that the user equipment regains radio coverage provided by the terrestrial radio access network, the user equipment continues to be served by the terrestrial radio access network.

Additionally, the present invention relates to a program comprising a computer readable program code which, when executed on a computer and/or on a user equipment and/or on a network node of a mobile communication network, or in part on a user equipment and/or in part on the network node of the mobile communication network, causes the computer and/or the user equipment and/or the network node of the mobile communication network to perform exemplary embodiments of the inventive method.

Still additionally, the present invention relates to a computer-readable medium comprising instructions which when executed on a computer and/or on a user equipment and/or on a network node of a mobile communication network, or in part on a user equipment and/or in part on the network node of the mobile communication network, causes the computer and/or the user equipment and/or the network node of the mobile communication network to perform exemplary embodiments of the inventive method.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

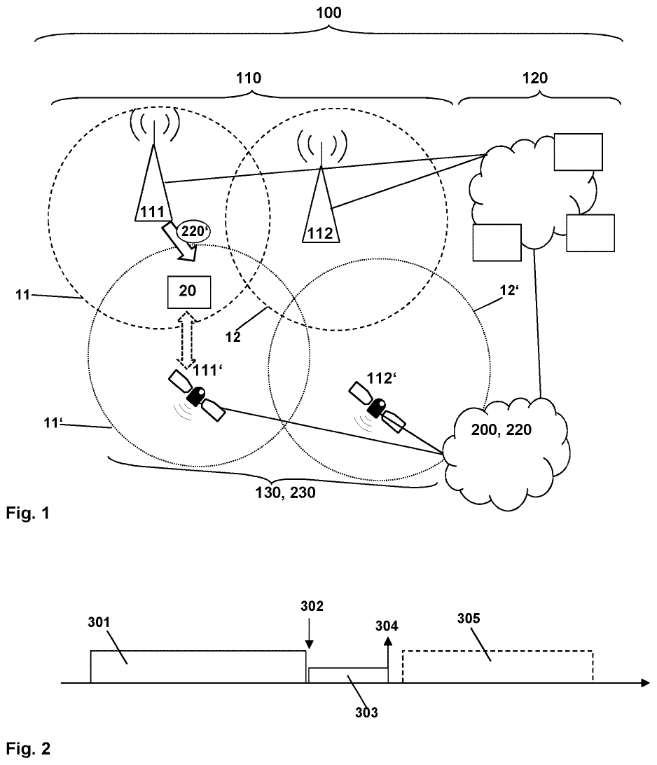

In FIG. 1, a telecommunications network 100 comprising an access network, and a core network 120 is schematically shown. The telecommunications network 100 or also mobile communication network 100 is typically realized as a cellular network or cellular mobile communication network 100. The mobile communication network 100, especially the core network 120, typically comprises a number of network functions or services that are not specifically indicated via a reference sign. The access network 110 or radio access network 110 comprises a plurality of radio cells 11, 12, i.e. geographical areas served, respectively, by base station entities. In the exemplary situation or scenario shown in FIG. 1, a first base station entity 111 generates or is associated with or spans the first (terrestrial) radio cell 11, and a second base station entity 112 generates or is associated with or spans the second (terrestrial) radio cell 12 (the first and second (terrestrial) radio cells 11, 12 being represented, in FIG. 1, via dashed circles around the first and second base station entities 111, 112, respectively). The base station entities 111, 112 typically realize gNB functionality or next-generation gNB functionality. The mobile communication network 100 is typically connected to a plurality of user equipments (or, rather, the user equipments are connected to the telecommunications network 100). FIG. 1 schematically only shows one user equipment 20, i.e. the situation of that user equipment 20 is represented in the communication network 100, whose (above mentioned) radio access network 110 is realized as a terrestrial radio access network 110, i.e. the radio access network 110 realizes the terrestrial radio access network (part) of the mobile communication network 100 (that is able to provide the user equipment 20 with radio access network functionality).

FIG. 1 additionally shows a non-terrestrial radio access network which is preferably realized, according to the present invention, via (or as) a satellite radio access network or satellite non-terrestrial radio access network. The non-terrestrial radio access network is designated via reference sign 130 in case that the non-terrestrial radio access network is part of the mobile communication network 100 (i.e. part of the radio access network of that mobile communication network 100, comprising both the terrestrial radio access network 110, and the non-terrestrial radio access network 130). However, while this latter configuration is possible, the present invention nevertheless mainly addresses a configuration where the non-terrestrial radio access network is not part of the mobile communication network 100 but part of a further telecommunications network 200, or a further mobile communication network 200 (also comprising a further core network 220, both the further corer network 220 and the further mobile communication network 200 being schematically represented, in FIG. 1, via a cloud representation 200, 220, the further mobile communication network 200 being connected to the core network 120 of the mobile communication network 100 and the further core network 220 being connected to the non-terrestrial radio access network), in which case the non-terrestrial radio access network is designated via reference sign 230.

In any case, the user equipment 20 is able to be provided with radio access network functionality both via the terrestrial radio access network 110 and via the non-terrestrial radio access network 130, 230, and the non-terrestrial radio access network 130, 230 is especially able to complement the radio coverage provided by the terrestrial radio access network 110. The non-terrestrial radio access network 130, 230 likewise comprises base station entities (or, at least, antenna entities or functionalities) that are schematically and exemplarily represented, in FIG. 1, as a first satellite 111′ and a second satellite 112′, wherein the first satellite 111′ provides radio coverage in a first satellite (or non-terrestrial) radio cell 11′ and the second satellite 112′ provides radio coverage in a second satellite (or non-terrestrial) radio cell 12′ (the first and second satellite (non-terrestrial) radio cells 11′, 12′ being represented, in FIG. 1, via dotted circles around the first and second satellites 111′, 112′, respectively).

FIG. 1 specifically shows the situation where the user equipment 20 is connected with, or served by, the first (terrestrial) base station entity 111 as part of the terrestrial radio access network 110.

Hence, according to the present invention, the mobile communication network 100 provides communication services to the user equipment 20 using the terrestrial radio access network 110 that provides radio access network functionality to the user equipment 20. Additionally, and complementary, radio access network functionality is able to be provided, to the user equipment 20, via the non-terrestrial radio access network 130, 230; furthermore, the user equipment 20 is able to switch (or to be switched) between the terrestrial radio access network 110 and the non-terrestrial radio access network 130, 230 (i.e. from being provided with radio access network functionality either via the terrestrial radio access network 110 or via the non-terrestrial radio access network 130, 230). In a situation of low or inexistent radio access network functionality being provided (or able to be provided) via the terrestrial radio access network 110 (and/or able to be received by the user equipment 20), it is provided according to the present invention that—after the user equipment 20 detecting such loss of radio coverage—a delay time interval is applied by the user equipment 20 prior to initiating a selection procedure.

This is schematically illustrated in FIG. 2 which exemplarily shows timing details that are related to an exemplary embodiment of the inventive method and inventive user equipment 20: It is assumed that the (considered) user equipment 20 is served (during a certain time period) by the terrestrial radio access network 110. This is schematically illustrated, in FIG. 2, via reference sign 301 on the left-most portion of a horizonal arrow schematically indicating the evolution of time. At a certain point in time, this radio coverage (provided by the terrestrial radio access network 110) ends or becomes insufficient (especially, but not limited to, due to the user equipment 20 moving towards a peripheral part of the corresponding radio cell) and, at a point in time indicated by an arrow and reference sign 302, such loss of radio coverage is detected by the user equipment 20 (first step of an exemplary embodiment of the inventive method).

In such a situation in a conventionally known mobile communication network, such a user equipment is typically configured such that it would almost immediately start (or initiate) with selection procedures, such as a cell re-selection procedure and/or a cell selection procedure and/or a public land mobile network selection procedure.

According to the present invention, the user equipment 20 is configured such that, subsequently—i.e. after the above-mentioned detection of a loss of radio coverage provided by the terrestrial radio access network 110—, the user equipment 20 applies a delay time interval prior to initiating a selection procedure (second step of an exemplary embodiment of the inventive method). In FIG. 2, the delay time interval is indicated via reference sign 303 and the point in time at which the selection procedure is initiated (by the user equipment 20) is indicated via reference sign 304.

Subsequently, the (considered) user equipment 20 is served (during a certain time period, schematically illustrated, in FIG. 2, via reference sign 305 on the right-most portion of the horizonal arrow indicating time evolution) by either the non-terrestrial radio access network 130, 230 or by the terrestrial radio access network 110; these two possibilities being represented, in FIG. 2, via the time portion 305 being illustrated via a dashed line; furthermore, the time portion 305 is illustrated via a dashed line as it is contemplated that its beginning is (temporally) moved further to ‘the left’ i.e. towards, or in the direction of, the point in time 302 (when the loss of radio coverage is detected):

According to the present invention, in case that (the situation of) loss of radio coverage (provided by the terrestrial radio access network 110) is still detected upon expiry of the delay time interval 303 (as shown in FIG. 2), the user equipment 20 initiates the selection procedure 304 with regard to the non-terrestrial radio access network 130, 230; however, in case that the user equipment 20 regains its radio coverage (provided by the terrestrial radio access network 110)—this corresponding to the time portion 305 (shown in FIG. 2, at least its beginning) being moved ‘to the left’ (compared to the representation of FIG. 2), at least beyond the end of the delay time interval 303—, the user equipment 20 continues to be served by the terrestrial radio access network 110, i.e. despite there having been a loss of coverage 302 detected by the user equipment 20, due to applying the delay time interval 303 prior to initiating a potential selection procedure 304 (at the end of the delay time interval 303), no switch towards the non-terrestrial radio access network 130, 230 has been initiated (and no preparatory selection procedure performed), thus saving energy resources at least at the side of the user equipment 20. Hence, in a third step of an exemplary embodiment of the inventive method, in case that the loss of radio coverage (provided by the terrestrial radio access network 110) is still detected upon expiry of the delay time interval 303, the user equipment 20 initiates the selection procedure 304 with regard to the non-terrestrial radio access network 130, 230, and alternatively, in case that the user equipment 20 regains radio coverage provided by the terrestrial radio access network 110, the user equipment 20 continues to be served by the terrestrial radio access network 110. Thus, as one of these two possibility necessarily occurs, it could also have been worded such that, in the third step, one out of the following two scenarios is applied:
the loss of radio coverage (provided by the terrestrial radio access network 110) is still detected upon expiry of the delay time interval 303, leading to the user equipment 20 initiating the selection procedure 304 with regard to the non-terrestrial radio access network 130, 230, and
the user equipment 20 regains radio coverage provided by the terrestrial radio access network 110 (the detected loss of coverage 302 is terminated) and the user equipment 20 continues to be served by the terrestrial radio access network 110.

According to the present invention, the selection procedure 304 is according to one category of selection procedures or according to a plurality of categories of selection procedures. Preferably, the selection procedure 304 whose initiation is delayed, in the second step, by the application of the delay time interval 303 corresponds to at least one out of the following, preferably to all out of the following:
a public land mobile network selection procedure,
a cell selection procedure,
a cell re-selection procedure.

Especially according to the present invention, the delay time interval 303 that is actually applied corresponds to—or is, at least partly, defined by or dependent on—a time to select satellite parameter, TSS parameter, or its information content, the delay time interval or this time to select satellite parameter being schematically represented, in FIG. 1, via reference sign 220.

Hence, in order to prevent the unnecessary change (of the user equipment 20) from the terrestrial radio access network 110 to the non-terrestrial radio access network 130, 230 and back to the terrestrial radio access network 110 (and thus minimizing signaling, registration (procedures), related radiofrequency power and waste of energy of the user equipment 20), the present invention uses the time to select satellite parameter in order to indicate, or define, the delay time interval 303 applied in (or prior to) mobility procedures of cellular user equipments interworking between terrestrial radio access networks and non-terrestrial radio access networks.

According to the present invention, the time to select satellite parameter/delay time interval 303 is especially used as follows (pseudo code):
IF the terrestrial radio access network 110 (TN) is lost (302)
   Start timer TSS (i.e. the delay time interval 303, defined via the time to select satellite parameter 202);
IF timer TSS expired
   Start search for NON-TERRESTRIAL NETWORK (i.e. start or initiate the selection procedure 304)
ELSE proceed normally (i.e. the user equipment 20 continues to be served by the terrestrial radio access network 110)

It is preferred according to the present invention that the time to select satellite parameter 220 is received, by the user equipment 20, from the terrestrial radio access network 110, especially from a base station entity 111 thereof and especially from the base station entity 111 serving the user equipment 20 at, or prior to, the point in time when, during the first step, the user equipment 20 detects the loss of radio coverage.

It is furthermore preferred according to the present invention that the delay time interval corresponds to—and/or that the time to select satellite parameter 220 indicates a time interval (TSS timer) of—2 s or 3 s or 4 s or 5 s or 6 s or 8 s or 10 s or 20 s or 30 s or other multiples of 10 s, especially up to 360 seconds.

However, it is especially possible according to the present invention, that—at least in specific situations of the user equipment 20, e.g. high-speed situations or premium customers or the like—the time to select satellite parameter 220 indicates a length of the delay time interval 303 of zero seconds, i.e. in such situations, and despite the time to select satellite parameter 220 being transmitted, the delay time interval is logically applied but-as its temporal length corresponds to zero—no delay time interval is actually (or physically) applied; hence, it should be possible, according to the present invention, that one specific information content of the time to select satellite parameter 220 is such that the time to select satellite parameter 220 indicates—in case of having this specific information content—that the delay time interval 303 (logically) applied in the second step is set to zero or corresponds to zero seconds, resulting in the user equipment 20 immediately initiating the selection procedure 304 with regard to the non-terrestrial radio access network 130, 230 if it detects a loss of radio coverage provided by the terrestrial radio access network 110.

Furthermore especially, the time to select satellite parameter 220 is either broadcast in a radio cell on a broadcast channel BCH, e.g. the broadcast control channel, of the serving radio cell in an appropriate system information block, SIB, especially in a system information block relevant for all user equipments within that (considered) radio cell; alternatively, the time to select satellite parameter 220 is sent using dedicated signaling to the user equipment 20 (either as part of the registration procedures, or as part of a regular non-access stratum procedure as for example a tracking area update (TAU), which can also be used to configure equivalent public land mobile network (ePLMN) functionality to the user equipment 20.

Especially, the present invention is applied to moving user equipments especially in geographical areas where the terrestrial radio access network radio coverage might be lost temporarily and is regained shortly after (e.g. due to tunnels, shading effects etc.).

Furthermore, it is preferred according to the present invention that either the user (of the user equipment 20) or the (mobile communication) network 100 or the service (e.g. of an application) (or a mix thereof) is able to set (i.e. to modify) the time to select satellite parameter 220, and, as a consequence, also the length of the delay time interval 303 applied (e.g. via a preference such as “immediately change to sat network/non-terrestrial radio access network” or “delayed change to sat network/non-terrestrial radio access network”).

Especially according to the present invention, it is preferred that the delay time interval 303 that is actually applied depends—in addition to the information content of the time to select satellite parameter 220—also on at least one out of the following:
a direction of movement information of the user equipment 20 relating to in which direction the user equipment 20 is heading and/or
a location information of the user equipment 20, especially a combination of a direction of movement information of the user equipment 20 relating to in which direction the user equipment 20 is heading and from which location of the user equipment 20,
a mobility mode or a mobility state criterium of the user equipment 20, especially on whether the user equipment 20 rather is or corresponds to one out of the following:
   stationary or quasi-stationary or not moving,
   comparatively slow moving or normal-mobility state criterium,
   comparatively faster moving or medium-mobility state criterium,
   moving at high-speed or high-mobility state criterium,
      wherein especially the delay time interval 303 that is actually applied is determined based on the information content of the time to select satellite parameter 220, wherein this value is increased or decreased dependent on the direction of movement information of the user equipment 20 and/or the location information of the user equipment 20 and/or the mobility mode of or the mobility state criterium applicable to the user equipment 20. Especially, it is preferred according to the present invention that a direction of movement (or a heading information) of the user equipment 20 is able to be taken into consideration for modulating the delay time interval 303 that is actually applied.

Furthermore especially, not only the direction of movement (or heading information) but also combined with (at least a coarse) location information relating to the user equipment 20 is able to be taken into consideration for modulating the delay time interval 303 that is actually applied; for example, the coverage area of a radio cell might be—roughly—divided into circular ring zone, indicating a distance from the cell's center; especially for user equipments 20 being located in the outer circular ring zones, their associated heading information, especially if directing to the outside of the radio cell (i.e. still farther from the center of the radio cell), might be taken into consideration for modulating the delay time interval 303 that is actually applied; for example, a different (longer or shorter) delay time interval 303 might be signaled (and, hence, applied by the user equipment 20) if a user equipment 20 is progressively leaving a radio cell in a first direction (e.g. corresponding to a south-westwardly direction of movement of the user equipment 20—or using a specific route such as a road, a motorway or a train line) than compared to this user equipment 20 progressively leaving the same radio cell in a second direction (e.g. corresponding to a eastwardly direction of movement of the user equipment 20—or using a specific further route such as a road, a motorway or a train line): in case it is known that in the first direction (or on the specific route) a higher likelihood of a white spot area is to be experienced (compared to in the second direction or on the specific further route), the delay time interval 303 signaled (and to be applied) might be longer for a user equipment 20 heading in the first direction (or having a high likelihood of following the specific route) compared to for a user equipment 20 heading in the second direction (or having a high likelihood of following the specific further route). Such information might be signaled in a dedicated manner to individual user equipments or groups of user equipments in the respective geographical area (of a radio cell); alternatively, such information content might also be broadcast within the respective radio cell in a manner such that the respective user equipments are able to extract and accordingly compute the delay time interval 30 to be applied accordingly.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for using a user equipment with a mobile communication network and/or for an energy-saving operation of the user equipment with the mobile communication network, wherein the mobile communication network provides communication services to the user equipment using a radio access network that serves or provides radio coverage to the user equipment,
wherein at least a part of the radio access network corresponds to a terrestrial radio access network that provides radio access network functionality to the user equipment, wherein additional, radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network,
wherein, the method comprises the following steps:
in a first step, the user equipment is served by the terrestrial radio access network and detects a loss of radio coverage provided by the terrestrial radio access network;
in a second step, the user equipment applies a delay time interval prior to initiating a selection procedure least-with regard to the non-terrestrial radio access network, the selection procedure being according to one or more categories of selection procedures; and
in a third step:
in case that loss of radio coverage provided by the terrestrial radio access network is still detected upon expiry of the delay time interval, the user equipment initiates the selection procedure with regard to the non-terrestrial radio access network, or
in case that the user equipment regains radio coverage provided by the terrestrial radio access network, the user equipment continues to be served by the terrestrial radio access network.

2. The method according to claim 1, wherein the selection procedure whose initiation is delayed, in the second step, by the application of the delay time interval corresponds to at least one out of the following:
a public land mobile network selection procedure,
a cell selection procedure, or
a cell re-selection procedure.

3. The method according to claim 1, wherein the delay time interval actually applied corresponds to—or is, at least partly, defined by or dependent on—a time to select satellite (TSS) parameter or its information content.

4. The method according to claim 3, wherein the delay time interval that is actually applied depends, in addition to the information content of the TSS parameter, also on at least one out of the following:
direction of movement information of the user equipment relating to in which direction the user equipment is heading;
location information of the user equipment; and/or
a mobility mode or a mobility state criterium of the user equipment.

5. The method according to claim 3, wherein the delay time interval that is actually applied depends on
a user-defined and/or network-defined and/or service-defined individual or dedicated setting solely, or
the user-defined and/or network-defined and/or service-defined individual or dedicated setting in addition to the information content of the TSS parameter.

6. The method according to claim 3, wherein the TSS parameter is broadcast, by at least one out of the base station entities of the terrestrial radio access network;
wherein a broadcast channel is used to transmit the TSS parameter, wherein this broadcasting is performed using a system information block that is relevant for all user equipments in the considered radio cell.

7. The method according to claim 3, wherein the TSS parameter is transmitted, to the user equipment, by the base station entity currently or previously serving the user equipment via using a dedicated signaling channel.

8. The method according to claim 3, wherein the TSS parameter is stored in a memory of the user equipment; and/or
wherein TSS parameter indicates that the delay time interval applied in the second step is set to zero or corresponds to zero seconds, resulting in the user equipment immediately initiating the selection procedure with regard to the non-terrestrial radio access network based on detecting a loss of radio coverage provided by the terrestrial radio access network.

9. The method according to claim 3, wherein the TSS parameter indicates that the delay time interval corresponds to 2 seconds, 3 seconds, 4 seconds, 5 seconds, 6 seconds, 8 seconds, 10 seconds, 20 seconds, 30 seconds, or to another multiple of 10 seconds.

10-13. (canceled)

14. A user equipment for use with a mobile communication network and/or for an energy-saving operation with the mobile communication network, wherein the mobile communication network provides communication services to the user equipment using a radio access network that serves or provides radio coverage to the user equipment,
wherein at least a part of the radio access network corresponds to a terrestrial radio access network that provides radio access network functionality to the user equipment, wherein additional radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network,
wherein the user equipment comprises:
a memory having processor-executable instructions stored thereon; and
a processor configured to execute the processor-executable instructions to facilitate the following being performed by the user equipment:
in a first step, the user equipment is served by the terrestrial radio access network and detects a loss of radio coverage provided by the terrestrial radio access network;
in a second step, the user equipment applies a delay time interval prior to initiating a selection procedure with regard to the non-terrestrial radio access network, the selection procedure being according to one category of selection procedures or according to a plurality of categories of selection procedures; and
in a third step:
in case that loss of radio coverage provided by the terrestrial radio access network is still detected upon expiry of the delay time interval, the user equipment initiates the selection procedure with regard to the non-terrestrial radio access network, or
in case that the user equipment regains radio coverage provided by the terrestrial radio access network, the user equipment continues to be served by the terrestrial radio access network.

15. A non-transitory computer-readable medium having processor-executable instructions stored thereon for using a user equipment with a mobile communication network and/or for an energy-saving operation of the user equipment with the mobile communication network, wherein the mobile communication network provides communication services to the user equipment using a radio access network that serves or provides radio coverage to the user equipment,
wherein at least a part of the radio access network corresponds to a terrestrial radio access network that provides radio access network functionality to the user equipment, wherein additional radio access network functionality is able to be provided, to the user equipment, via a non-terrestrial radio access network, wherein the user equipment is able to switch or to be switched from being provided with radio access network functionality either via the terrestrial radio access network or via the non-terrestrial radio access network,
wherein the processor-executable instructions, when executed, facilitate performance of the following:
in a first step, the user equipment is served by the terrestrial radio access network and detects a loss of radio coverage provided by the terrestrial radio access network;
in a second step, the user equipment applies a delay time interval prior to initiating a selection procedure with regard to the non-terrestrial radio access network, the selection procedure being according to one or more categories of selection procedures; and
in a third step: in case that loss of radio coverage provided by the terrestrial radio access network is still detected upon expiry of the delay time interval, the user equipment initiates the selection procedure with regard to the non-terrestrial radio access network, or
in case that the user equipment regains radio coverage provided by the terrestrial radio access network, the user equipment continues to be served by the terrestrial radio access network.

16. The method according to claim 3, wherein the TSS parameter is received, by the user equipment, from the terrestrial radio access network.

17. The method according to claim 16, wherein the TSS parameter is received from a base station entity serving the user equipment at, or prior to, the point in time when, during the first step, the user equipment detects the loss of radio coverage.

18. The method according to claim 4, wherein the mobility mode or the mobility state criterium of the user equipment is on whether the user equipment rather is or corresponds to one out of the following:
stationary or quasi-stationary or not moving,
comparatively slow moving or normal-mobility state criterium,
comparatively faster moving or medium-mobility state criterium, or
moving at high-speed or high-mobility state criterium.

19. The method according to claim 4, wherein the delay time interval that is actually applied is determined based on the information content of the TSS parameter, wherein this value is increased or decreased dependent on the direction of movement information of the user equipment and/or the location information of the user equipment and/or the mobility mode of or the mobility state criterium applicable to the user equipment.

20. The method according to claim 7, wherein the TSS parameter is transmitted as part of, or during, one out of the following:
a registration process of the user equipment with the mobile communication network and/or the terrestrial radio access network;
a non-access stratum procedure of the user equipment with the mobile communication network and/or the terrestrial radio access network; or
an access stratum procedure of the user equipment with the mobile communication network and/or the terrestrial radio access network.
